(19) United States
(12) Patent Application Publication
(10) Pub. No.: US 2026/0163817 A1
(43) Pub. Date: Jun. 11, 2026

(54) RADIO FREQUENCY (RF) CALIBRATION METHOD AND APPARATUS THEREOF

(71) Applicant: MEDIATEK INC., Hsinchu City (TW)

(72) Inventors: An-Rong WU, Hsinchu City (TW); Ting-Ying LI, Hsinchu City (TW); Wen Ting CHEAH, Hsinchu City (TW); Wen-Chih CHEN, Hsinchu City (TW); Kun-Ying LIN, Hsinchu City (TW); Hsin-Chung CHEN, Hsinchu City (TW)

(21) Appl. No.: 19/407,277

(22) Filed: Dec. 3, 2025

Related U.S. Application Data
(60) Provisional application No. 63/728,269, filed on Dec. 5, 2024.

(51) Int. Cl. H04L 41/16; H04L 41/14

(52) U.S. Cl. CPC H04L 41/16; H04L 41/145

(57) ABSTRACT

A radio frequency (RF) calibration method is provided. The RF calibration method may be applied to an apparatus. The RF calibration method may include the following steps. The apparatus may obtain a plurality of calibration data. Then, the apparatus may divide the plurality of calibration data into different groups according to different frequency bands. Then, the apparatus may use an artificial intelligence (AI) model to perform a pre-training on each group to obtain an initial setting that corresponds to each group. Then, the apparatus may use the AI model to perform a training on each calibration data according to the initial setting corresponding to each group.

### CROSS REFERENCE TO RELATED APPLICATIONS

This application claims the benefit of U.S. Provisional Application No. 63/728,269 filed on Dec. 5, 2024, the entirety of which is incorporated by reference herein.

### BACKGROUND OF THE INVENTION

### Field of the Invention

The invention generally relates to radio frequency (RF) calibration technology, and more particularly, it relates to performing the RF calibration through a pre-training mechanism and an adaptive outlier boundary adjustment.

### Description of the Related Art

Unless otherwise indicated herein, approaches described in this section are not prior art to the claims listed below and are not admitted as prior art by inclusion in this section.

In conventional technologies, the radio frequency (RF) calibration is a crucial process that ensures the radio components of the device operate correctly and efficiently. The artificial intelligence (AI) training process for fast handset calibration (FHC) may involve AI-based pathloss prediction for frequency points. FHC AI may train the models using calibration identifiers (CIDs). This process may reduce the number of calibration frequency points required by the machine. However, the training process for FHC AI is time-intensive due to the extensive and complex calibration dataset. Therefore, how to achieve a balance between training speed and performance may be a challenge in FHC AI.

In addition, due to the influence of the production environment or materials, the calibrated data itself may have a certain range of variation. Therefore, the prediction results from the AI model may generate errors.

Therefore, how to perform RF calibration more accurately and efficiently is a topic that is worthy of discussion.

### BRIEF SUMMARY OF THE INVENTION

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods, and apparatus pertaining to radio frequency (RF) calibration with respect to an apparatus. It is believed that the issue described above can be avoided or otherwise alleviated by implementing one or more of the proposed schemes described herein.

An embodiment of the invention provides an RF calibration method. The RF calibration method may be applied to an apparatus. The RF calibration method may comprise the following steps. The apparatus may obtain a plurality of calibration data. Then, the apparatus may divide the plurality of calibration data into different groups according to different frequency bands. Then, the apparatus may use an artificial intelligence (AI) model to perform pre-training on each group to obtain the initial setting that corresponds to each group. Then, the apparatus may use the AI model to perform training on each calibration data according to the initial setting corresponding to each group.

In some embodiments, each calibration data may correspond to a path, and each path may be associated with a calibration identifier (CID).

In some embodiments, the calibration data in the same group may be trained according to the same initial setting.

In some embodiments, the apparatus may further determine whether the pre-training result for a group meets a criterion. The apparatus may retrain the group in an event that the pre-training result for the group does not meet the criterion.

In some embodiments, the apparatus may further determine whether to adjust an outlier boundary corresponding to each calibration data according to the training result for each calibration data. The apparatus may adjust the outlier boundary corresponding to each calibration data according to the training result in an event that the training result does not meet a criterion.

An embodiment of the invention provides an apparatus. The apparatus may comprise a transceiver and a processor. During operation, the transceiver may wirelessly communicate with a network node. The processor may be coupled to the transceiver such that, during operation, the processor performs the following operations. The processor may obtain a plurality of calibration data. The processor may divide the plurality of calibration data into different groups according to different frequency bands. The processor may use an AI model to perform pre-training on each group to obtain the initial setting that corresponds to each group. In addition, the processor may use the AI model to perform training on each calibration data according to the initial setting corresponding to each group.

An embodiment of the invention provides an RF calibration method. The RF calibration method may be applied to an apparatus. The RF calibration method may comprise the following steps. The apparatus may obtain a plurality of calibration data. Then, the apparatus may use an AI model to perform training on each calibration data to generate a training result for each calibration data. Then, the apparatus may determine whether to adjust an outlier boundary corresponding to each calibration data according to the training result for each calibration data.

An embodiment of the invention provides an apparatus. The apparatus may comprise a transceiver and a processor. During operation, the transceiver may communicate with at least one device under test (DUT) to collect a plurality of calibration data. The processor may be coupled to the transceiver such that, during operation, the processor performs the following operations. The processor may obtain the plurality of calibration data. The processor may use an AI model to perform training on each calibration data to generate a training result for each calibration data. The processor may determine whether to adjust an outlier boundary corresponding to each calibration data according to the training result for each calibration data.

Other aspects and features of the invention will become apparent to those with ordinary skill in the art upon review of the following descriptions of specific embodiments of the RF calibration methods and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating an RF calibration process according to an embodiment of the invention.

FIG. 5 is a schematic diagram illustrating an example of groups for different bands according to an embodiment of the invention.

FIG. 6 is a schematic diagram illustrating an example of a training model according to an embodiment of the invention.

FIG. 7 is a schematic diagram illustrating outlier detection of an RF calibration process in the training phase according to an embodiment of the invention.

FIG. 8 is a schematic diagram illustrating an RF calibration process according to another embodiment of the invention.

FIG. 9 is a schematic diagram illustrating outlier boundary according to an embodiment of the invention.

FIG. 10 is a schematic diagram illustrating outlier detection of an RF calibration process in the inference phase according to an embodiment of the invention.

FIG. 11 is a schematic diagram illustrating an example of offset according to an embodiment of the invention.

FIG. 12 is a flow chart illustrating an RF calibration method according to an embodiment of the invention.

FIG. 13 is a flow chart illustrating an RF calibration method according to another embodiment of the invention.

FIG. 14 is a block diagram illustrating an RF calibration apparatus according to an embodiment of the application.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

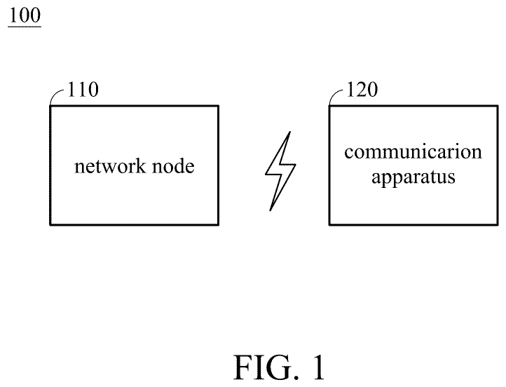

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the communication apparatus 120 may be in wireless communication with a wireless network including a non-terrestrial network (NTN) and a TN via the network node 110. That is, the network node 110 may be a terrestrial network node (e.g., an eNB, a gNB, or a transmission/reception point (TRP)) and/or a non-terrestrial network node (e.g., a satellite). For example, the terrestrial network node and/or the non-terrestrial network node may form an NTN serving cell for wireless communication with the communication apparatus 120. In another embodiment, the network node 110 may be an entity compatible with the Institute of Electrical and Electronics Engineers (IEEE) 802.11 standards to provide and manage access to the wireless medium for the communication apparatus 120.

In the embodiments of the invention, the communication apparatus 120 may be a user equipment (UE), a non-AP station (STA), a smartphone, a Personal Data Assistant (PDA), a pager, a laptop computer, a desktop computer, a wireless handset, or any computing device that includes a wireless communications interface. In addition, the communication apparatus 120 may be an entity compatible with the Institute of Electrical and Electronics Engineers (IEEE) 802.11 standards.

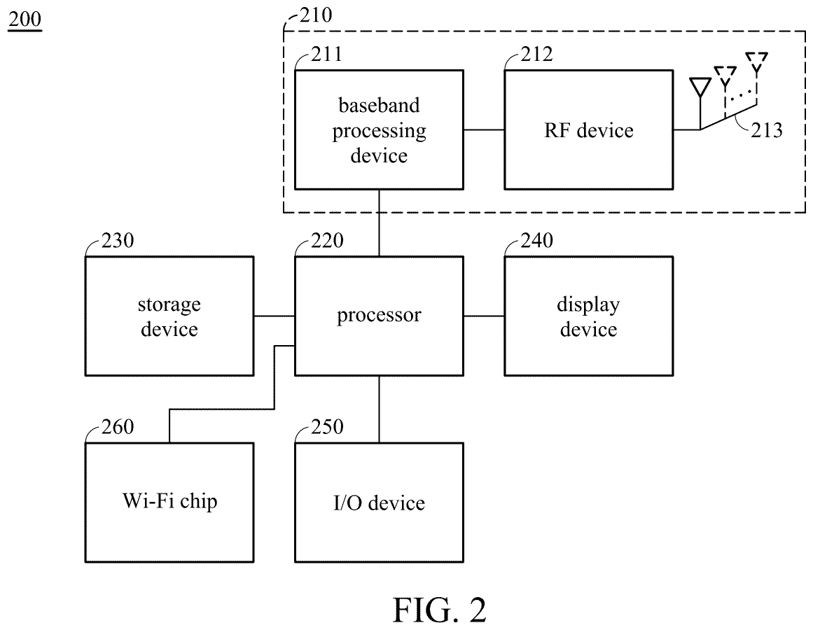

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, an analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

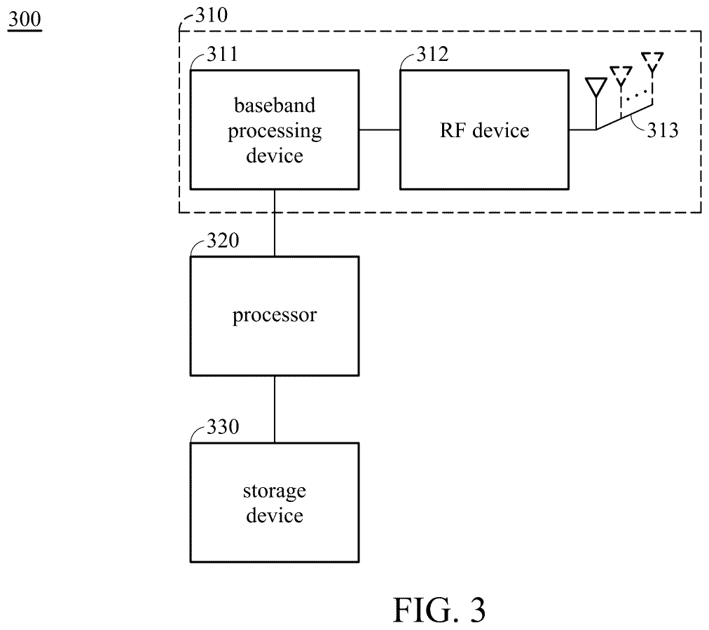

FIG. 3 is a block diagram illustrating a network node 300 according to an embodiment of the application. The network node 300 can be applied to the network node 120. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and an antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, an analog-to-digital converter (ADC)/digital-to-analog converter (DAC), etc..

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311 to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

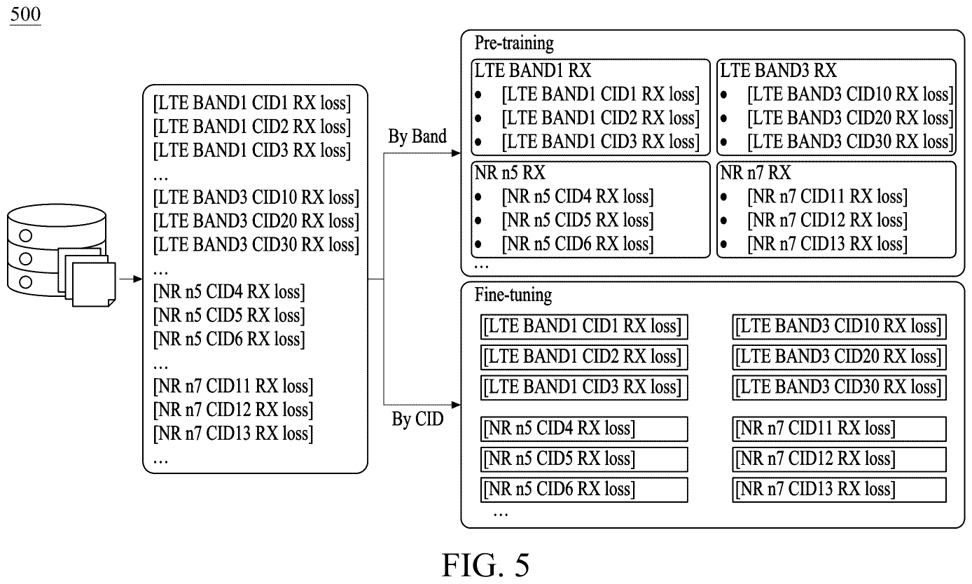

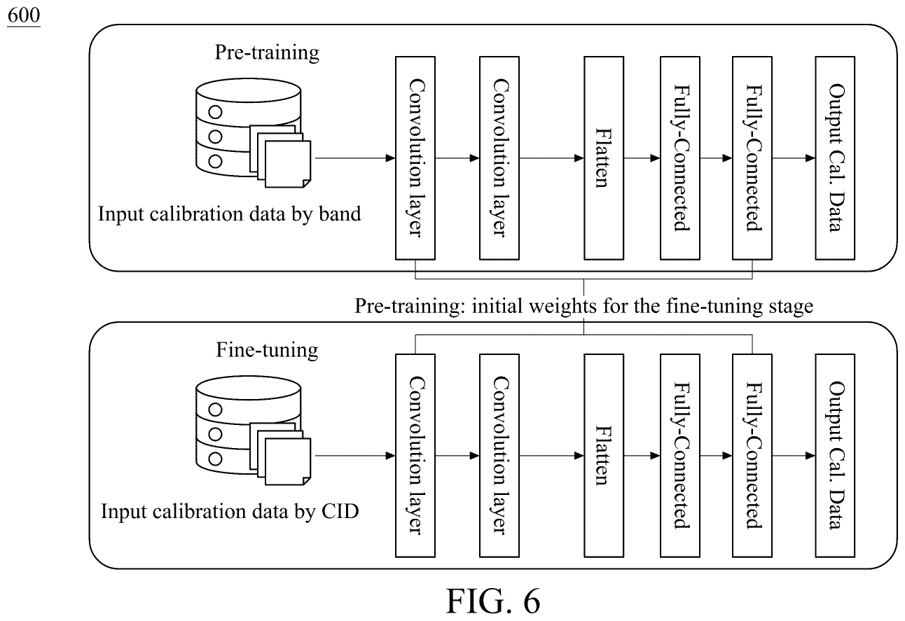

According to an embodiment of the invention, an apparatus (e.g., RF calibration apparatus 1400) may obtain or collect a plurality of calibration data of at least one device under test (DUT) (e.g., communication apparatus 120) for the RF calibration process. Then, the apparatus may divide the plurality of calibration data into different groups according to different frequency bands (e.g., the different LTE bands and NR bands shown in FIG. 5, but the invention should not be limited thereto). Then, the apparatus may use an artificial intelligence (AI) model (e.g., the neural network model shown in FIG. 6, but the invention should not be limited thereto) to perform pre-training on each group to obtain the initial setting that corresponds to each group (e.g., initial weight of each model of each group, and/or initial parameter setting values of each model of each group, but the invention should not be limited thereto). Then, the apparatus may use the AI model to perform training on each calibration data according to the initial setting corresponding to each group.

According to an embodiment of the invention, each calibration data may correspond to a path. In addition, each path may be associated with a calibration identifier or index (CID). Each calibration data may comprise the information of its corresponding path, e.g., frequency band, CID number, a reception (RX) path loss, but the invention should not be limited thereto (e.g., [LTE BAND1 CID1 RX loss] shown in FIG. 5).

According to an embodiment of the invention, in the fine-tuning stage, the calibration data in the same group may be trained according to the same initial setting.

According to an embodiment of the invention, the apparatus may determine whether the pre-training result for a group meets a criterion. In an event that the pre-training result for the group does not meet the criterion, the apparatus may retrain the group. According to an embodiment of the invention, the criterion may be ((an error mean of the calibration data+3 * error standard deviation of the calibration data)<0.4), but the invention should not be limited thereto.

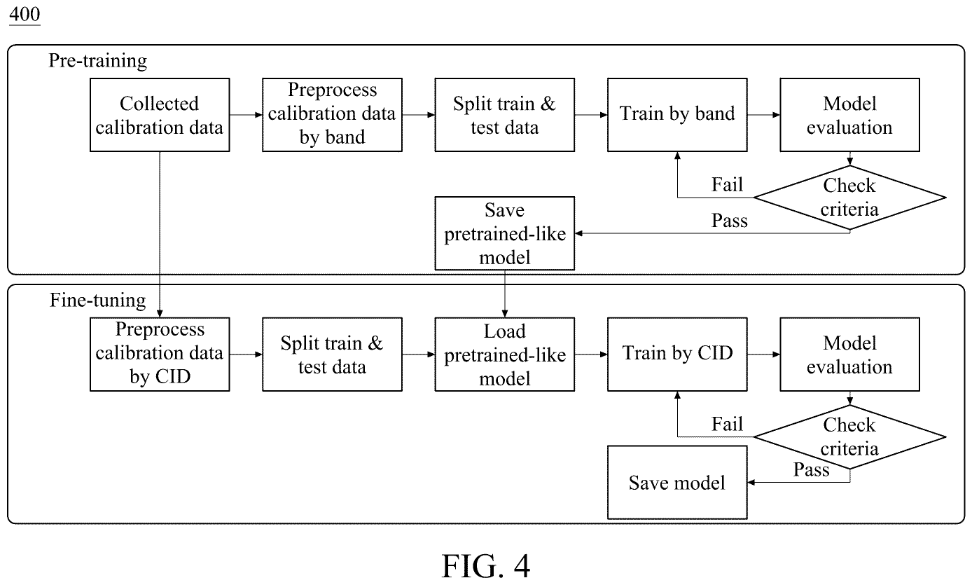

FIG. 4 is a schematic diagram illustrating an RF calibration process 400 according to an embodiment of the invention. The RF calibration process 400 can be applied to an RF calibration apparatus (e.g., the RF calibration apparatus 1400). As shown in FIG. 4, in the pre-training stage, the apparatus may collect the calibration data of at least one DUT (e.g., communication apparatus 120). In some embodiments, the apparatus may collect the calibration data from about 300 DUTs. Then, the apparatus may preprocess the collected calibration data by band. Specifically, the apparatus may divide the calibration data into different groups according to different frequency bands (e.g., different LTE bands and NR bands shown in FIG. 5, but the invention should not be limited thereto).

Then, the apparatus may also divide the band-based calibration data into the training data and the test data. The training data may be used to train the AI model. The test data may be used to test the accuracy of the AI model.

Then, the apparatus may use an AI model (e.g., the neural network model shown in FIG. 6) to train the training data of the band-based calibration data by band. That is, the apparatus may train each group to obtain the initial setting that corresponds to each group. Specifically, the apparatus may train each group to generate a model corresponding to each group, and each model may have its corresponding initial setting (e.g., initial weight of each model of each group, and/or initial parameter setting values of each model of each group, but the invention should not be limited thereto).

Then, the apparatus may perform a model evaluation operation on the model of each group to generate the pre-training result for each group. Then, the apparatus may determine whether each pre-training result for each group meets a criterion. If the pre-training result for a group does not meet the criterion (i.e., Fail), the apparatus may retrain the group. If the pre-training result for the group meets the criterion (i.e., Pass), the apparatus may save the model (i.e., pretrained-like model) of the group.

In the fine-tuning stage, the apparatus may preprocess the collected calibration data by CID. Specifically, the apparatus may divide the calibration data according to the CID of each calibration data (as shown in FIG. 5).

Then, the apparatus may also divide the CID-based calibration data into the training data and the test data. The training data may be used to train the AI model. The test data may be used to test the accuracy of the AI model.

Then, the apparatus may load the saved model (i.e., pretrained-like model) of each group. Then, the apparatus may use an AI model (e.g., the neural network model shown in FIG. 6) to train the training data of the CID-based calibration data by band. That is, the apparatus may train each calibration data according to the initial setting corresponding to each group. The calibration data in the same group may be trained according to the same initial setting. After the training (by CID), the apparatus may generate a model corresponding to each calibration data, and the model of each calibration data may have its corresponding setting.

Then, the apparatus may perform a model evaluation operation on the model of each calibration data to generate a training result for each calibration data. Then, the apparatus may determine whether each training result for each calibration data meets a criterion. If the training result for a calibration data does not meet the criterion (i.e., Fail), the apparatus may retrain the calibration data. If the pre-training result for the calibration data meets the criterion (i.e., Pass), the apparatus may save the model of the calibration data.

FIG. 5 is a schematic diagram illustrating an example 500 of groups for different bands according to an embodiment of the invention. As shown in FIG. 5, in the pre-training stage, a plurality of calibration data may be divided into different groups according to different frequency bands. For example, as shown in FIG. 5, the group for frequency band LTE BAND 1 may comprise calibration data [LTE BAND1 CID1 RX loss], [LTE BAND1 CID2 RX loss], and [LTE BAND1 CID3 RX loss]. The group for the frequency band LTE BAND3 RX may comprise calibration data [LTE BAND3 CID10 RX loss], [LTE BAND3 CID20 RX loss], and [LTE BAND3 CID30 RX loss]. The group for the frequency band NR n5 RX may comprise calibration data [NR n5 CID4 RX loss], [NR n5 CID5 RX loss], and [NR n5 CID6 RX loss]. The group for the frequency band NR n7 RX may comprise calibration data [NR n7 CID11 RX loss], [NR n7 CID12 RX loss], and [NR n7 CID13 RX loss].

FIG. 6 is a schematic diagram illustrating an example 600 of a training model according to an embodiment of the invention. As shown in FIG. 6, an AI model used in the pre-training stage and the fine-tuning stage may comprise two convolution layers, a flatten layer, and two fully-connected layers. The AI model may output the trained calibration data (i.e., the model corresponding to each group in the pre-training stage and the model corresponding to each calibration data in the fine-tuning stage).

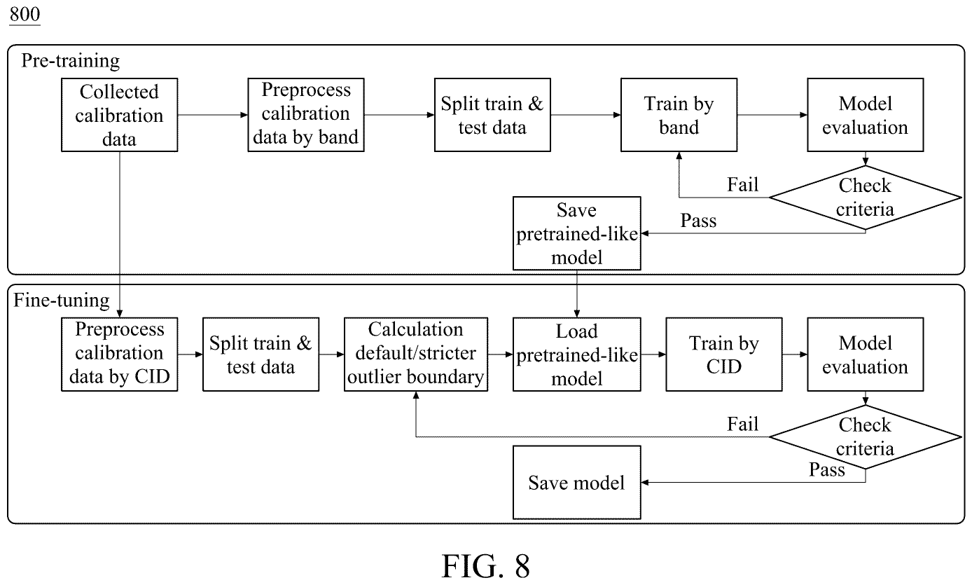

According to an embodiment of the invention, in the fine-tuning stage, the apparatus may further determine whether to adjust an outlier boundary corresponding to each calibration data according to the training result for each calibration data. In an event that the training result does not meet a criterion, the apparatus may adjust the outlier boundary corresponding to the calibration data according to the training result. Details are illustrated in FIG. 8 below.

According to an embodiment of another implementation of the invention, the apparatus (e.g., RF calibration apparatus 1400) may obtain or collect a plurality of calibration data of at least one device under test (DUT) (e.g., communication apparatus 120) for the RF calibration process. Then, the apparatus may use an AI model to perform the training on each calibration data to generate the training result for each calibration data. Then, the apparatus may determine whether to adjust an outlier boundary corresponding to each calibration data according to the training result for each calibration data. In an event that the training result corresponding to one of the calibration data does not meet a criterion, the apparatus may adjust the outlier boundary corresponding to this calibration data according to the training result.

According to an embodiment of the invention, the outlier boundary may comprise an upper bound and a lower bound. In an embodiment, the default (or initial) outlier upper bound may be defined as ((the mean of training data)+3 *standard deviation of training data). The default (or initial) outlier lower bound may be defined as ((the mean of training data)−3 *standard deviation of training data).

According to an embodiment of the invention, the criterion may comprise that an outlier false negative event has not occurred (i.e., outlier false negative==0), and (an error mean of prediction error of the calibration data+3* an error standard deviation of prediction error of the calibration data) is lower than a threshold (e.g., 0.4). The outlier false negative event means that the apparatus determines that the outlier has not occurred (e.g., the apparatus determines that the training result is not outside the outlier boundary), but the outlier actually occurs (e.g., the model prediction maximum error is larger than 1 dB).

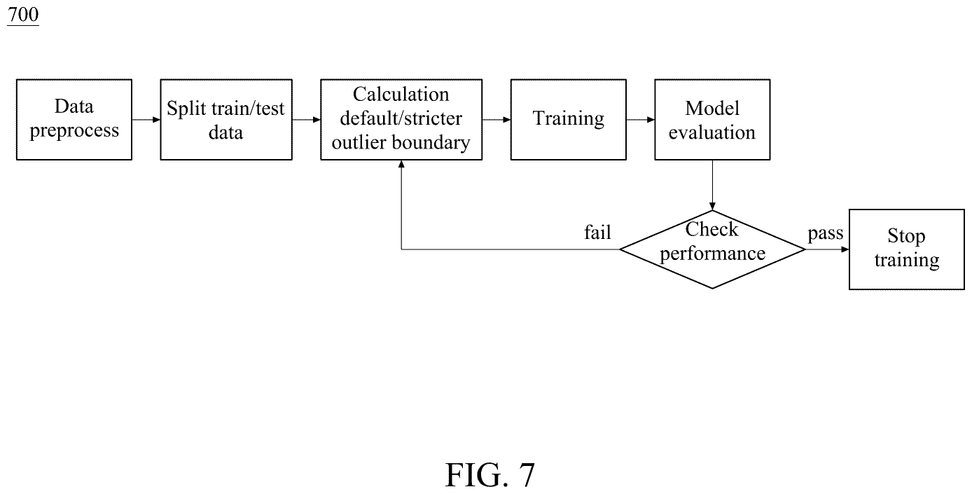

FIG. 7 is a schematic diagram illustrating outlier detection of an RF calibration process 700 in the training phase according to an embodiment of the invention. The RF calibration process 700 in the training phase can be applied to an RF calibration apparatus (e.g., the RF calibration apparatus 1400). As shown in FIG. 7, in the training phase, the apparatus may perform data preprocessing on the collected calibration data of at least one DUT (e.g., communication apparatus 120). Then, the apparatus may divide the calibration data into the training data and the test data. Then, the apparatus may calculate the outlier boundary (a default outlier boundary definition or a stricter (or adaptive) outlier boundary definition) to filter the calibration data (i.e., filter out the calibration data that is outside the outlier boundary). Then, the apparatus may train the filtered calibration data. Then, the apparatus may perform a model evaluation operation on the model of each calibration data to generate a pre-training result for each calibration data. Then, the apparatus may determine whether each training result for each calibration data meets a criterion (e.g., the number of outlier false negative events==0 and (error mea +3 * error standard deviation)<0.4, but the invention should not be limited thereto). If the training result for a calibration data does not meet the criterion (i.e., Fail), the apparatus may determine to adjust the outlier boundary corresponding to the calibration data according to the training result for the calibration data. If a pre-training result for a group meets the criterion (i.e., Pass), the apparatus may stop training the calibration data.

FIG. 8 is a schematic diagram illustrating an RF calibration process 800 according to another embodiment of the invention. The RF calibration process 800 can be applied to an RF calibration apparatus (e.g., the RF calibration apparatus 1400). As shown in FIG. 8, in the pre-training stage, the apparatus may collect the calibration data of at least one DUT (e.g., communication apparatus 120). Then, the apparatus may preprocess the collected calibration data by band. Specifically, the apparatus may divide the calibration data into different groups according to different frequency bands (e.g., different LTE bands and NR bands shown in FIG. 5, but the invention should not be limited thereto).

Then, the apparatus may also divide the band-based calibration data into the training data and the test data. The training data may be used to train the AI model. The test data may be used to test the accuracy of the AI model.

Then, the apparatus may use an AI model (e.g., the neural network model shown in FIG. 6) to train the training data of the band-based calibration data by band. That is, the apparatus may train each group to obtain the initial setting that corresponds to each group. Specifically, the apparatus may train each group to generate a model corresponding to each group, and each model may have its corresponding initial setting (e.g., initial weight of each model of each group, and/or initial parameter setting values of each model of each group, but the invention should not be limited thereto).

Then, the apparatus may perform a model evaluation operation on the model of each group to generate a pre-training result for each group. Then, the apparatus may determine whether each pre-training result for each group meets a criterion. If a pre-training result for a group does not meet the criterion (i.e., Fail), the apparatus may retrain the group. If a pre-training result for a group meets the criterion (i.e., Pass), the apparatus may save the model (i.e., pretrained-like model) of the group.

In the fin-tuning stage, the apparatus may preprocess the collected calibration data by CID. Specifically, the apparatus may divide the calibration data according to the CID of each calibration data (as shown in FIG. 5).

Then, the apparatus may also divide the CID-based calibration data into the training data and the test data. The training data may be used to train the AI model. The test data may be used to test the accuracy of the AI model.

Then, the apparatus may calculate the outlier boundary (a default outlier boundary definition or a stricter (or adaptive) outlier boundary definition) to filter the calibration data (i.e., filter out the calibration data that is outside the outlier boundary).

Then, the apparatus may load the saved model (i.e., pretrained-like model) of each group. Then, the apparatus may use an AI model (e.g., the neural network model shown in FIG. 6) to train the training data of the CID-based calibration data by band. That is, the apparatus may train each calibration data according to the initial setting corresponding to each group. The calibration data in the same group may be trained according to the same initial setting. After the training (by CID), the apparatus may generate a model corresponding to each calibration data, and the model of each calibration data may have its corresponding setting.

Then, the apparatus may determine whether each training result for each calibration data meets a criterion (e.g., the number of outlier false negative events==0 and (error mean+3 * error standard deviation)<0.4, but the invention should not be limited thereto). If the training result for a calibration data does not meet the criterion (i.e., Fail), the apparatus may determine to adjust the outlier boundary corresponding to the calibration data according to the training result for the calibration data. If the training result for the calibration data meets the criterion (i.e., Pass), the apparatus may save the model of the calibration data.

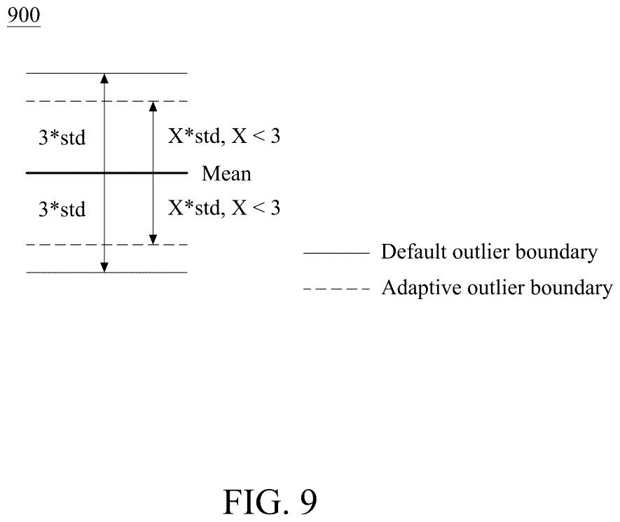

FIG. 9 is a schematic diagram illustrating the outlier boundary 900 according to an embodiment of the invention. As shown in FIG. 9, the default (or initial) outlier upper bound may be defined as ((the mean of training data)+3 *standard deviation of training data). The default (or initial) outlier lower bound may be defined as ((the mean of training data)−3 *standard deviation of training data). If training result for each calibration data does not meet the criterion (the number of outlier false negative events ==0 and (error mean+3 * error standard deviation)<0.4), the outlier boundary may be adjusted according to the training result. For example, if the training result for each calibration data is (the number of outlier false negative events>A (i.e. not==0) and (error mean+3 * error standard deviation) >B (i.e., not<0.4)), the outlier boundary may be adjusted according to a value X corresponding to A and B. Specifically, the outlier upper bound may be adjusted to ((the mean of training data)+X * standard deviation of training data). The default (or initial) outlier lower bound may be adjusted to ((the mean of training data)−X *standard deviation of training data), where X is less than 3. Different values of A and B may correspond to a value of X. The relationship among A, B, and X can be pre-defined. For example, the relationship among A, B, and X can be pre-defined in a table.

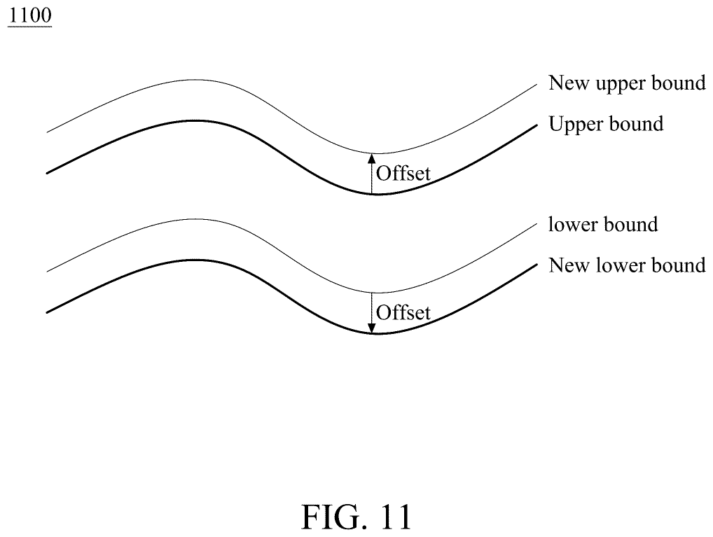

According to an embodiment of the invention, in an inference phase, the outlier boundary may be further adjusted according to an offset value. Specifically, in the inference phase, the apparatus may determine whether an outlier occurs according to the outlier boundary and the offset value (e.g., the new upper bound and the new lower bound shown in FIG. 11). In an event that an outlier occurs, the apparatus may perform a full calibration operation (e.g., the calibration operation may be performed using normal test equipment without using the AI model).

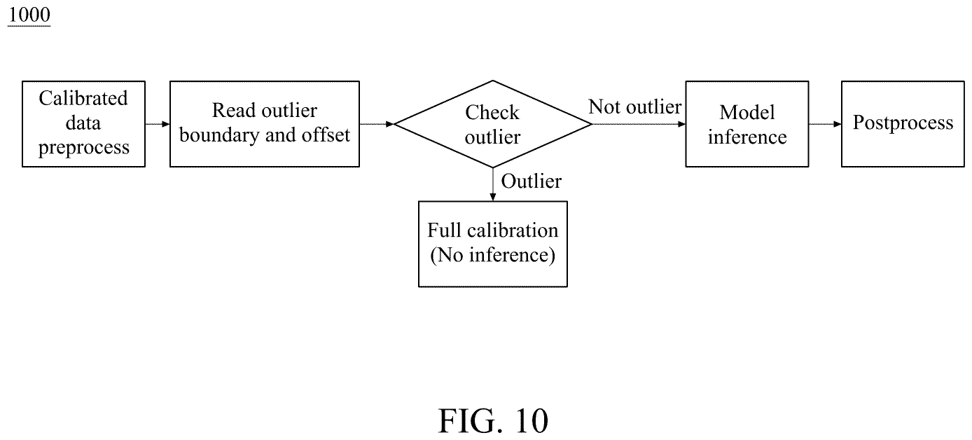

FIG. 10 is a schematic diagram illustrating outlier detection of an RF calibration process 1000 in the inference phase according to an embodiment of the invention. The RF calibration process 1000 can be applied to an RF calibration apparatus (e.g., the RF calibration apparatus 1400). As shown in FIG. 10, in the inference phase, the apparatus may perform the data preprocessing on the collected calibration data of at least one DUT (e.g., communication apparatus 120). Then, the apparatus may read the outlier boundary and the offset. Then, the apparatus may determine whether an outlier occurs according to the outlier boundary and the offset value (e.g., the new upper bound and the new lower bound shown in FIG. 11). If an outlier occurs, the apparatus may perform a full calibration operation (e.g., the calibration operation may be performed using normal test equipment rather than an AI model). If there is no outlier, the apparatus may perform a model inference operation and postprocess (e.g., the calibration operation is performed using an AI model).

FIG. 11 is a schematic diagram illustrating an example 1100 of offset according to an embodiment of the invention. As shown in FIG. 11, in an inference phase, the outlier boundary may be adjusted according to an offset value. For example, the new upper bound may be generated by adding the offset value to the original upper bound, and the new lower bound may be generated by subtracting the offset value from the original lower bound.

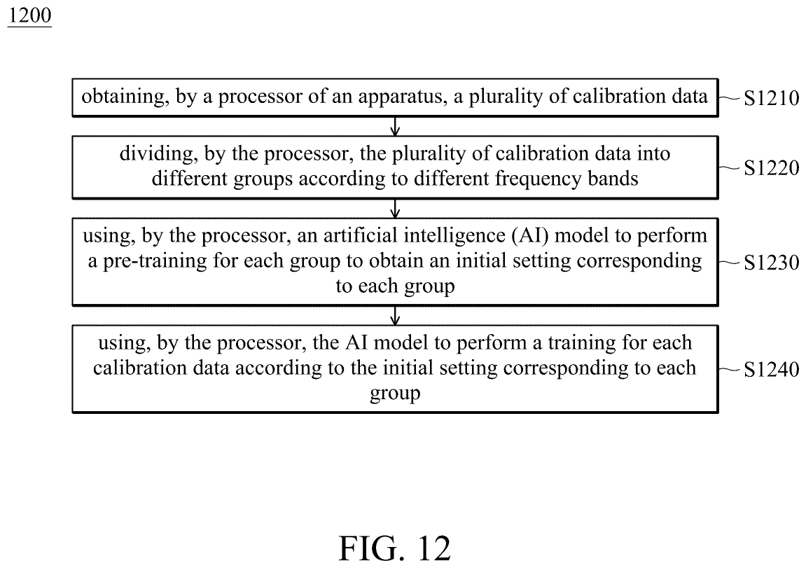

FIG. 12 is a flow chart illustrating an RF calibration method 1200 according to an embodiment of the invention. The RF calibration method 1200 can be applied to the RF calibration apparatus 1400. As shown in FIG. 12, in step S1210, the RF calibration apparatus 1400 may obtain a plurality of calibration data.

In step S1220, the RF calibration apparatus 1400 may divide the plurality of calibration data into different groups according to different frequency bands.

In step S1230, the RF calibration apparatus 1400 may use an AI model to perform pre-training on each group to obtain the initial setting that corresponds to each group.

In step S1240, the RF calibration apparatus 1400 may use the AI model to perform training on each calibration data according to the initial setting corresponding to each group.

According to an embodiment of the invention, in the RF calibration method 1200, each calibration data may correspond to a path. Each path may be associated with a CID.

According to an embodiment of the invention, in the RF calibration method 1200, the calibration data in the same group may be trained according to the same initial setting.

According to an embodiment of the invention, in the RF calibration method 1200, the RF calibration apparatus 1400 may determine whether a pre-training result for a group meets a criterion. The RF calibration apparatus 1400 may retrain the group in an event that the pre-training result for the group does not meet the criterion.

According to an embodiment of the invention, in the RF calibration method 1200, the RF calibration apparatus 1400 may determine whether to adjust an outlier boundary corresponding to each calibration data according to the training result for each calibration data. The RF calibration apparatus 1400 may adjust the outlier boundary corresponding to each calibration data according to the training result in an event that the training result does not meet a criterion.

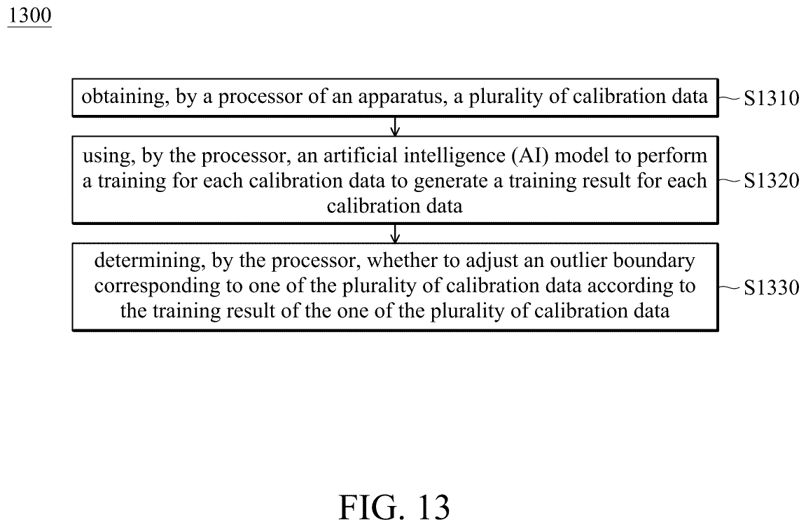

FIG. 13 is a flow chart illustrating an RF calibration method 1300 according to another embodiment of the invention. The RF calibration method 1300 can be applied to the RF calibration apparatus 1400. As shown in FIG. 13, in step S1310, the RF calibration apparatus 1400 may obtain an apparatus, a plurality of calibration data.

In step S1320, the RF calibration apparatus 1400 may use an AI model to perform training on each calibration data to generate a training result for each calibration data.

In step S1330, the RF calibration apparatus 1400 may determine whether to adjust an outlier boundary corresponding to each calibration data according to the training result for each calibration data.

According to an embodiment of the invention, in the RF calibration method 1300, the RF calibration apparatus 1400 may adjust the outlier boundary corresponding to each calibration data according to the training result in an event that the training result does not meet a criterion.

According to an embodiment of the invention, in the RF calibration method 1300, the criterion may comprise that an outlier false negative event has not occurred, and (an error mean+3* an error standard deviation) is lower than a threshold.

According to an embodiment of the invention, in the RF calibration method 1300, in an inference phase, the outlier boundary may be further adjusted according to an offset value.

According to an embodiment of the invention, in the RF calibration method 1300, the RF calibration apparatus 1400 may determine whether an outlier occurs according to the outlier boundary and the offset value. The RF calibration apparatus 1400 may perform a full calibration operation in an event that an outlier occurs.

According to the RF calibration methods provided in the embodiments of the invention, the band-based pretraining and retraining mechanisms are introduced to the RF calibration process. Therefore, the number of training epochs by CID will be reduced, and the model performance will be increased. In addition, the RF calibration methods provided in the embodiments of the invention may ensure that the model input data remains within a reasonable range to prevent any abnormal values from being fed into the model during production line calibration. While maintaining model performance, the number of retraining instances can be reduced, and the training time can be decreased.

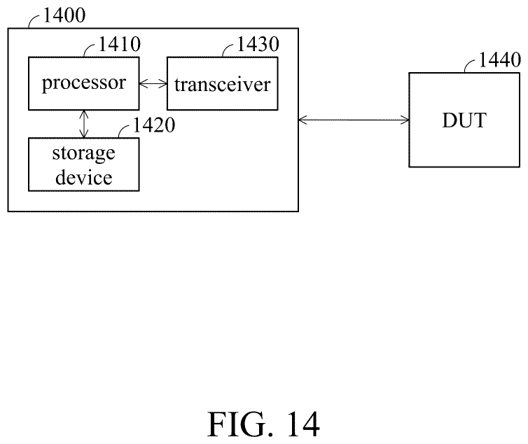

FIG. 14 is a block diagram illustrating an RF calibration apparatus 1400 according to an embodiment of the application. The RF calibration apparatus 1400 may be used to perform the RF calibration on a DUT 1440 (e.g., communication apparatus 120). As shown in FIG. 14, the calibration apparatus 1400 may comprise a processor 1410, a storage device 1420, and a transceiver 1430. It should be noted that, in order to clarify the concept of the invention, FIG. 14 presents a simplified block diagram in which only the elements relevant to the invention are shown. However, the invention should not be limited to what is shown in FIG. 14. In some embodiments, the RF calibration apparatus 1400 may be a computing device such as a computer or a server that can perform the RF calibration operations according to the embodiments of the invention, but the invention should not be limited thereto.

The processor 1410 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, storing and retrieving data (e.g., program code) to and from the storage device 1420, and controlling the transceiver 1430 for communications with the DUT 1440.

In particular, the processor 1410 coordinates the aforementioned operations of the storage device 1420 and the transceiver 1430 for performing the method of the present application.

As will be appreciated by persons skilled in the art, the circuits of the processor 1410 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 1420 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

In some embodiments, the transceiver 1430 may directly communicate with the DUT to obtain the calibration data from the DUT 1440. In other embodiments, the transceiver 1430 may communicate with the DUT indirectly, for example, via a RF calibration meter, to obtain the calibration data from the DUT 1440.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It should be noted that although not explicitly specified, one or more steps of the methods described herein can include a step for storing, displaying, and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or incorporated.

While the invention has been described by way of example and in terms of a preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A radio frequency (RF) calibration method, comprising:
obtaining, by a processor of an apparatus, a plurality of calibration data;
dividing, by the processor, the plurality of calibration data into different groups according to different frequency bands;
using, by the processor, an artificial intelligence (AI) model to perform a pre-training on each group to obtain an initial setting corresponding to each group; and
using, by the processor, the AI model to perform a training on each calibration data according to the initial setting corresponding to each group.

2. The RF calibration method of claim 1, wherein each calibration data corresponds to a path, and wherein each path is associated with a calibration identifier (CID).

3. The RF calibration method of claim 1, wherein the calibration data in the same group are trained according to the same initial setting.

4. The RF calibration method of claim 1, further comprising:
determining, by the processor, whether a pre-training result of a group meets a criterion; and
retraining, by the processor, the group in an event that the pre-training result of the group does not meet the criterion.

5. The RF calibration method of claim 1, further comprising:
determining, by the processor, whether to adjust an outlier boundary corresponding to each calibration data according to a training result of each calibration data; and
adjusting, by the processor, the outlier boundary corresponding to each calibration data according to the training result in an event that the training result does not meet a criterion.

6. An apparatus, comprising:
a transceiver which, during operation, communicates with at least one device under test (DUT) to collect a plurality of calibration data; and
a processor communicatively coupled to the transceiver such that, during operation, the processor performs operations comprising:
obtaining the plurality of calibration data;
dividing the plurality of calibration data into different groups according to different frequency bands;
using an artificial intelligence (AI) model to perform a pre-training for each group to obtain an initial setting corresponding to each group; and
using the AI model to perform a training on each calibration data according to the initial setting corresponding to each group.

7. The apparatus of claim 6, wherein each calibration data corresponds to a path, and wherein each path is associated with a calibration identifier (CID).

8. The apparatus of claim 6, wherein the calibration data in the same group are trained according to the same initial setting.

9. The apparatus of claim 6, wherein the processor performs operations further comprising:
determining whether a pre-training result of a group meets a criterion; and
retraining the group in an event that the pre-training result of the group does not meet the criterion.

10. The apparatus of claim 6, wherein the processor performs operations further comprising:
determining whether to adjust an outlier boundary corresponding to each calibration data according to a training result of each calibration data; and
adjusting the outlier boundary corresponding to each calibration data according to the training result in an event that the training result does not meet a criterion.

11. A radio frequency (RF) calibration method, comprising:
obtaining, by a processor of an apparatus, a plurality of calibration data;
using, by the processor, an artificial intelligence (AI) model to perform a training on each calibration data to generate a training result for each calibration data; and
determining, by the processor, whether to adjust an outlier boundary corresponding to each calibration data according to the training result of each calibration data.

12. The RF calibration method of claim 11, further comprising:
adjusting, by the processor, the outlier boundary corresponding to each calibration data according to the training result in an event that the training result does not meet a criterion.

13. The RF calibration method of claim 11, wherein the criterion comprises that an outlier false negative event has not occurred, and (an error mean+3* an error standard deviation) is lower than a threshold.

14. The RF calibration method of claim 11, wherein in an inference phase, the outlier boundary is further adjusted according to an offset value.

15. The RF calibration method of claim 14, wherein in the inference phase, the method further comprises:
determining, by the processor, whether an outlier occurs according to the outlier boundary and the offset value; and
performing, by the processor, a full calibration operation in an event that the outlier occurs.
